(19) United States
(12) Patent Application Publication
(10) Pub. No.: US 2011/0087687 A1
(43) Pub. Date: Apr. 14, 2011

(54) POSITION SENSITIVE TYPE-AHEAD MATCHING FOR RESOURCE NAVIGATION

(75) Inventors: Pavan Kumar Immaneni, San Jose, CA (US); Steven K. Ma, San Jose, CA (US)

(73) Assignee: International Business Machines Corporation, Armonk, NY (US)

(21) Appl. No.: 12/578,906

(22) Filed: Oct. 14, 2009

(51) Int. Cl. G06F 17/30

(52) U.S. Cl. 707/769; 707/E17.014

(57) ABSTRACT

A type-ahead navigation feature typically allows users to navigate to a first resource whose name begins with an inputted character or a sequence of input characters typed in quick succession. The type-ahead navigation feature may not be useful when the resource name comprises multiple parts or where a first set of characters in the resource name is irrelevant in locating a requisite resource name. Functionality can be implemented to initiate the type-ahead navigation feature against any character position in the resource name. By providing the users with an ability to specify a part of the resource name or a character position within the resource name against which the type-ahead navigation feature should be initiated, resource navigation efficiency can be improved.

### BACKGROUND

Embodiments of the inventive subject matter generally relate to the field of computer systems and, more particularly, to position sensitive type-ahead matching for resource navigation.

Users typically use a type-ahead navigation feature to navigate through resources by typing a character. The type-ahead navigation feature allows the users to navigate to a first resource whose name begins with the typed character. In addition to single character matching, the type-ahead navigation feature also allows the users to input a sequence of characters in close succession to further refine a match for the resource.

### SUMMARY

Embodiments include a method comprising identifying a searchable name-part of a first resource name presented with a resource navigation graphical user interface in response to selecting of the first resource name. The searchable name-part comprises a searchable resource name portion demarcated with at least one delimiter. In response to input of a sequence of characters, the searchable name-part of a plurality of resource names accessible via the resource navigation graphical user interface is searched for the sequence of characters. A second of the plurality of resource names that has the searchable name part beginning with the sequence of characters is identified. Focus is shifted from the first resource name to the second of the plurality of resource names in the resource navigation graphical user interface.

Another embodiment includes a method comprising identifying an intermediate character position that corresponds to a character position indicated in a first resource name presented with a resource navigation graphical user interface. In response to an input of a sequence of characters, a plurality of resource names, accessible via the resource navigation graphical user interface is searched for the sequence of characters from the intermediate character position. A second of the plurality of resource names that comprises the sequence of characters beginning at the intermediate character position of the second of the plurality of resource names is identified. Focus is shifted from the first resource name to the second of the plurality of resource names in the resource navigation graphical user interface.

Another embodiment includes a computer program product for position sensitive type-ahead matching, where the computer program product comprises a computer usable medium comprising computer usable program code. The computer usable program code is configured to identify a searchable name-part of a first resource name presented with a resource navigation graphical user interface in response to selecting of the first resource name. The searchable name-part comprises a searchable resource name portion demarcated with at least one delimiter. The computer usable program code is configured to search, in response to input of a sequence of characters, the searchable name-part of a plurality of resource names accessible via the resource navigation graphical user interface for the sequence of characters. The computer usable program code is configured to identify a second of the plurality of resource names that has the searchable name part beginning with the sequence of characters. The computer usable program code is further configured to shift focus from the first resource name to the second of the plurality of resource names in the resource navigation graphical user interface.

Another embodiment includes an apparatus comprising a processor, a network interface coupled with the processor, and a resource navigation unit. The resource navigation unit is operable to identify a searchable name-part of a first resource name presented with a resource navigation graphical user interface in response to selecting of the first resource name. The searchable name-part comprises a searchable resource name portion demarcated with at least one delimiter. The resource navigation unit is operable to search, in response to input of a sequence of characters, the searchable name-part of a plurality of resource names accessible via the resource navigation graphical user interface for the sequence of characters. The resource navigation unit is also operable to identify a second of the plurality of resource names that has the searchable name part beginning with the sequence of characters. The resource navigation unit is further operable to shift focus from the first resource name to the second of the plurality of resource names in the resource navigation graphical user interface.

### BRIEF DESCRIPTION OF THE DRAWINGS

The present embodiments may be better understood, and numerous objects, features, and advantages made apparent to those skilled in the art by referencing the accompanying drawings.

FIG. 1 is a conceptual diagram illustrating resource navigation using position-sensitive type-ahead matching.

FIG. 2 is a flow diagram illustrating example operations for one embodiment of a position sensitive type-ahead navigation feature.

FIG. 3 is a flow diagram illustrating example operations for one embodiment of the position sensitive type-ahead navigation feature.

FIG. 4 is a flow diagram illustrating example operations for another embodiment of a position sensitive type-ahead navigation feature.

FIG. 5 is an example block diagram of a computer system configured for position sensitive type-ahead matching.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to a position based type-ahead navigation feature applied to a Rational Developer for System z (RDz) environment, the position based type-ahead navigation feature can be incorporated in various other environments such as a Windows® environment, a Linux® environment, etc. In other instances, well-known instruction instances, protocols, structures, and techniques have not been shown in detail in order not to obfuscate the description.

Resource navigators, for navigating through and locating a requisite resource from multiple available resources, typically support a type-ahead navigation feature whereby navigation focus is shifted to a first resource whose name begins with an inputted character. However, the existing type-ahead navigation feature does not allow the users to initiate type-ahead matching against positions other than a first character of the resource name. The type-ahead navigation feature becomes especially inefficient when the resource name comprises multiple parts—each part separated by a delimiter (e.g., a space)—but where a first part of the resource name is irrelevant. For example, on a Windows based file system, using the type-ahead navigation feature to locate a resource with a resource name “My Work Folder” from hundreds of other resources beginning with the letters “My” may be a time and labor intensive task. A resource navigation unit that provides users with an ability to apply the type-ahead navigation feature to any part of the resource name can improve efficiency of the resource navigator. The resource navigation unit can allow users to specify a part of the resource name or a specific character position within the resource name against which the type-ahead navigation feature should be initiated. This can improve the flexibility of the resource navigator, and reduce the time and effort associated with a visual search for a resource.

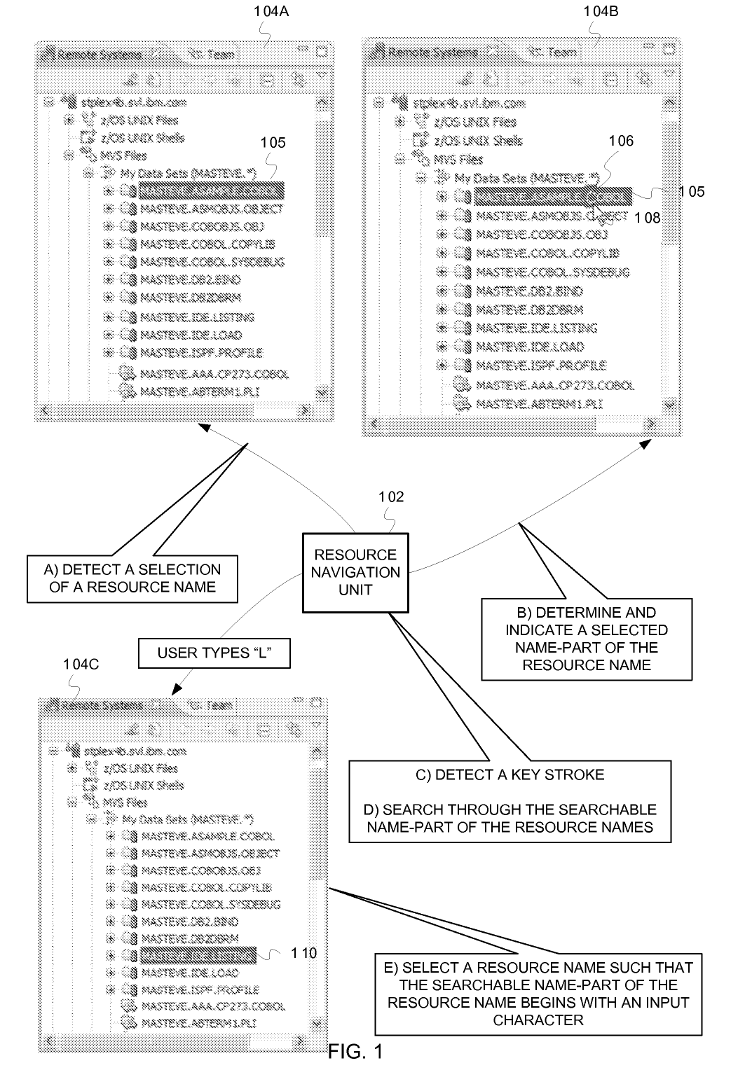

FIG. 1 is a conceptual diagram illustrating resource navigation using position-sensitive type-ahead matching. FIG. 1 depicts a resource navigation unit 102 and different instances of a resource navigation window.

At stage A, the resource navigation unit 102 detects a selection of a resource name 105. The resource name 105 is presented in a resource navigation graphical user interface. In one implementation, as illustrated in FIG. 1, the resource navigation graphical user interface is a resource navigation window 104A depicting a hierarchy of resource names in a tree format. In another implementation, the resource navigation graphical user interface can be an ordered/unordered list of resource names. As depicted in FIG. 1, the resource navigation window 104A presents a tree-view of resources in a Rational Developer for System z (RDz) environment. The resource navigation window 104A allows users to navigate through, view, and locate resources (e.g., files, applications, folders, data sets, and other heterogeneous resources hosted by a system). The resource navigation window 104A depicts multiple data sets (e.g., folders) each of which may comprise other data sets, files, etc. At stage A, the user selects data set 105 with name “MASTEVE.ASAMPLE.COBOL”. The data sets depicted in the resource navigation window 104A have three name-parts. Name-parts refer to distinct parts of a resource name and may be separated by a delimiter. The name-parts may comprise characters, numbers, etc. The delimiter may be a period, a space, a hyphen, an asterisks, etc. For the data set 105, the resource name comprises three name-parts (i.e., MASTEVE, ASAMPLE, and COBOL) each of which is separated by a period delimiter. As another example, on a Windows based file-system, a folder called “My Project Work Folder” comprises four name-parts (i.e., my, project, work, and folder) separated by a space delimiter. The user may use a mouse or any suitable pointing device (e.g., a finger or a stylus on a touch screen, etc.) to select the resource name.

At stage B, the resource navigation unit 102 determines and indicates a selected name-part of the selected resource name (“searchable name-part”). The searchable name-part refers to a name-part of the resource names in the resource navigation window 104A that will be searched to identify a requisite resource. In other words, the searchable name-part indicates the name-part against which type-ahead matching should be performed. The searchable name-part comprises a portion of the resource name demarcated by at least one delimiter. The resource navigation unit 102 can determine the searchable name-part of the selected resource name 105 by determining a position of a mouse pointer on the selected resource name 105. The resource navigation unit 102 may determine a cursor position of the mouse pointer. The resource navigation unit 102 may determine a range of positions (e.g., pixel values) of the selected resource name corresponding to each of the name-parts of the selected resource name. The resource navigation unit 102 can then compare the cursor position with the range of positions for each of the name-parts of the selected resource name and determine a range of positions (and an associated name-part) within which the cursor position lies.

In FIG. 1, the resource navigation unit 102 may determine a cursor position 108. For example, the cursor position 108 may be 130 pixels from the start of the selected resource name. The resource navigation unit 102 may then determine that a first-level name-part, MASTEVE, comprises pixels 1 through 80, a second-level name-part, ASAMPLE, comprises pixels 81 through 120, and a third-level name-part, COBOL, comprises pixels 121 through 160. On comparing the cursor position 108 with pixel ranges of the name-parts, the resource navigation unit 102 can determine that the cursor position 108 at pixel 130 lies within the range of pixels for the third-level name-part. Thus, the resource navigation unit 102 can determine that the user has clicked on the third level name-part 106 of the selected resource name 105. The resource navigation unit 102 can also indicate the searchable name-part 106 by presenting a visual indication of the searchable name-part. The resource navigation unit 102 may emphasize the searchable name-part, highlight the searchable name-part, change the font size, font color, and/or font emphasis of the searchable name-part, etc. This is indicated in resource window 104B, where the resource navigation unit 102 increases the font size of the third level name-part 106 of the resource name 105.

At stage C, the resource navigation unit 102 detects a key stroke. On detecting the key stroke, the resource navigation unit 102 initiates a type-ahead navigation feature against a first character of the searchable name-part. The key stroke can indicate a letter, a symbol, a number, etc. in a name of the requisite resource (“input character”). In some implementations, the user may be required to indicate selection of the searchable name-part (e.g., by placing a mouse pointer over the searchable name-part and pressing on a mouse button) while indicating the input character. In another implementation, after the resource navigation unit 102 visually indicates the searchable name-part, the user may no longer be required to continue selecting the searchable name-part.

At stage D, the resource navigation unit 102 searches through the searchable name-part of each of the resource names in the resource navigation window 104B. The resource navigation unit 102 searches through the resource names to identify a next resource such that the searchable name-part of the next resource begins with the input character. In FIG. 1, after the resource navigation unit 102 visually indicates the third level name-part 106, the user types a letter “L”. The resource navigation unit 102 searches through the resource names to identify a resource such that the third level name-part of the resource begins with the letter “L”.

At stage E, the resource navigation unit 102 selects the next resource name such that the searchable name-part of the resource name begins with the input character. As depicted in resource navigation window 104C, the resource navigation unit 102 locates resource 110 (“MASTEVE.IDE.LISTING”) because the third level name-part of the resource 110 begins with the letter “L”. The resource navigation unit 102 shifts navigation focus from the resource 105 to the resource 110. The resource navigation windows 104A, 104B, and 104C are not distinct windows and represent the same resource navigation window at different stages in time.

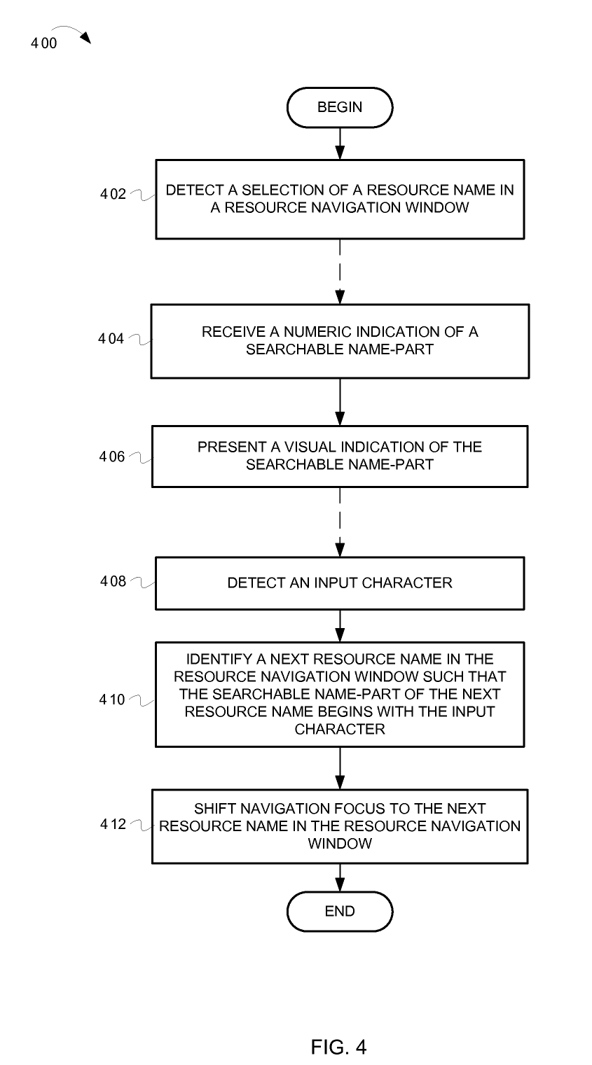

It should be noted that the operations described with reference to FIG. 1 are examples. In some implementations, the user may not indicate the searchable name-part by clicking on the searchable name-part for a specified period of time. Instead, the user may provide a numeric indication of the searchable name-part. For example, after selecting the resource 105, the user may type a number to indicate the searchable name-part. To indicate that a second level name-part of the resource name is the searchable name-part, the user may select the resource 105 and press “2”. Operations for providing a numeric indication of the searchable name-part are further described with reference to FIG. 4.

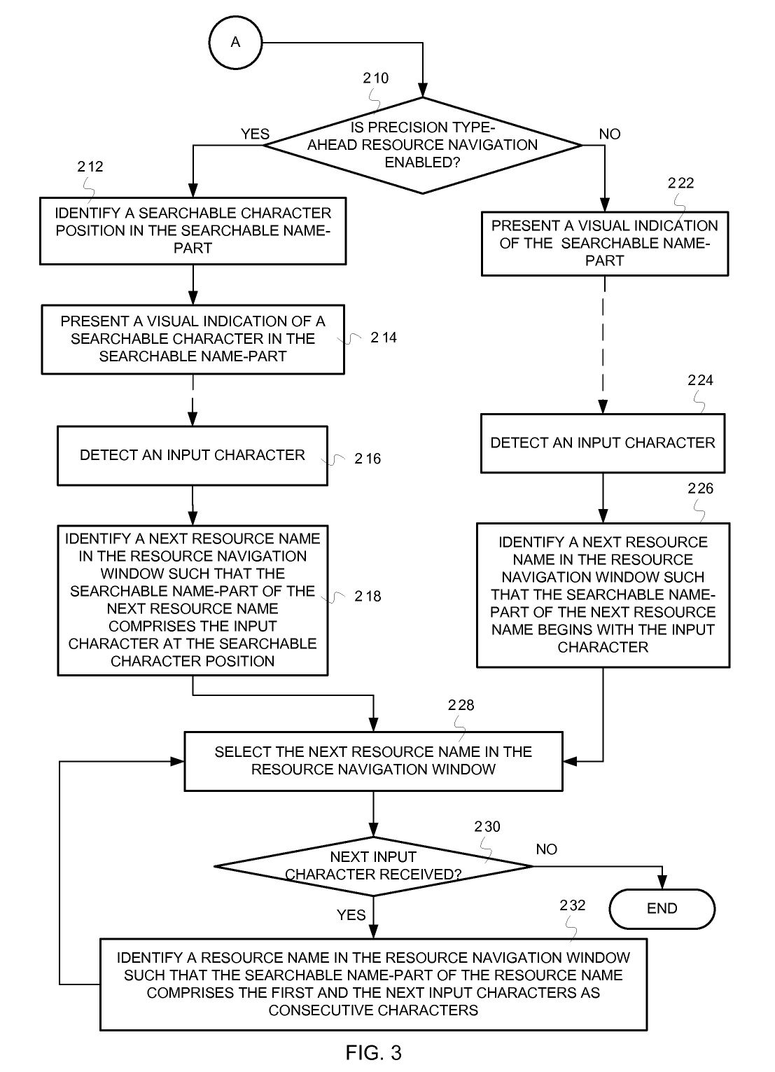

Also, in some implementations, the resource navigation unit 102 can be configured to provide a higher level of precision in enabling the user locate the requisite resource. Instead of initiating the type-ahead navigation feature against the first character of the searchable name-part, the user may have an option of selecting a searchable character position (not necessarily the first character) within the searchable name-part. On detecting the key strokes and identifying the input character, the resource navigation unit 102 can perform type-ahead matching against the searchable name-part beginning at the searchable character position as will be further described with reference to FIG. 3.

In the RDz environment described with reference to FIG. 1, the delimiter that separates one name-part from another is a system-specified delimiter (i.e., a period delimiter). However, in some implementations, the user may have an option of specifying one or more delimiters that should be used to separate the name-parts in the resource name. For example, the user may indicate that a space and hyphen delimiters will be used to separate the name-parts in the resource name. The resource navigation unit 102 can identify one of the space and the hyphen delimiters in the selected resource name, accordingly determine the range of positions corresponding to each of the name-parts of the selected resource name, and identify the searchable name-part.

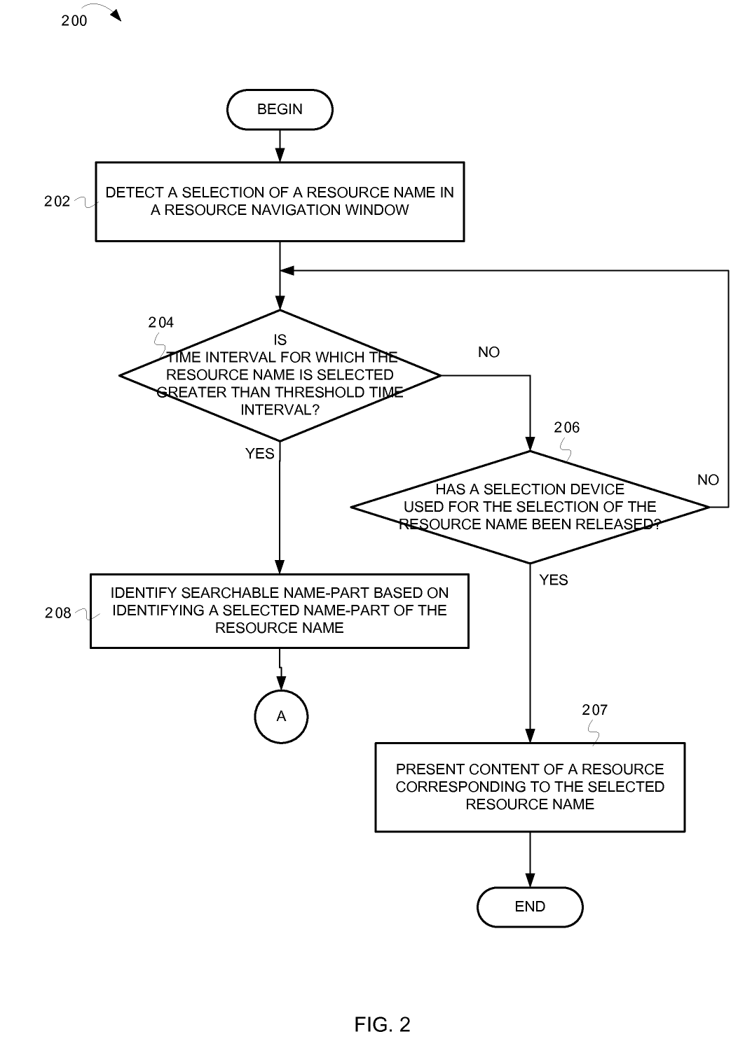

FIG. 2 and FIG. 3 are flow diagrams illustrating example operations for one embodiment of a position sensitive type-ahead navigation feature. Flow 200 begins at block 202 in FIG. 2.

At block 202, a selection of a resource name in a resource navigation window is detected. A user can select the resource name in the resource navigation window by using a mouse to click on the resource name, using a keyboard to select the resource name (e.g., using a tab key, arrow key, etc.), using a finger or a stylus to indicate the resource name on a touch screen, etc. The flow continues at block 204.

At block 204, it is determined whether a time interval for which the resource name is selected is greater than a threshold time interval. A searchable name-part may be indicated on the selected resource name by placing a mouse pointer over the searchable name-part and pressing on a mouse button for an interval of time greater than or equal to the threshold time interval. For example, the threshold time interval may be configured to be two seconds. However, the threshold time interval may be configured to be any suitable time interval. To indicate the searchable name-part, the user may press the mouse button to select the searchable name-part and keep the mouse button pressed (with the mouse pointer on the searchable name-part) for a time interval greater than or equal to two seconds. In another implementation, the user with a touch screen may be required to keep his/her finger or stylus in contact with the searchable name-part on the touch screen, for the threshold time interval, to indicate the searchable name-part. In another implementation, the user may hover (without clicking) the mouse pointer over the searchable name-part for the threshold time interval. If it is determined that the time interval for which the resource name is selected is greater than the threshold time interval, the flow continues at block 206. Otherwise, the flow continues at block 206.

At block 206, it is determined whether a selection device used for the selection of the resource name has been released. For example, it may be determined whether the mouse button used for selecting the resource name and consequently the searchable name-part has been released. Pressing the mouse button for the threshold time interval while positioning the mouse pointer on the searchable name-part can be used indicate the searchable name-part and may be used to enable a position based type-ahead navigation feature. The position based type-ahead navigation feature may not be initiated if it is determined that the mouse button was released before the threshold time interval elapsed. Also, as described earlier, any suitable selection device may be used to select and indicate the searchable name-part. For example, it may be determined whether a stylus, positioned over the searchable name-part on the touch screen, is in contact with the touch screen. If it is determined that the selection device used for the selection of the resource name is released, the flow continues at block 207. Otherwise, the flow contains at block 204, where it is determined whether the resource name has been selected for the threshold time interval.

At block 207, content of a resource corresponding to the selected resource name is presented. The flow 200 moves from block 206 to block 207 if it is determined that the selection device was released before the threshold time interval elapsed. The content of the resource can comprise resource data such as text, multimedia, etc. If the resource is a folder, the content of the resource can comprise a list or details of other resources within the selected folder. From block 207, the flow ends.

At block 208, a searchable name-part is identified based on identifying a selected name-part of the resource name. The flow 200 moves from block 204 to block 208 after it is determined that the time interval for which the resource name is selected is greater than the threshold time interval. The searchable name-part indicates a name-part against which type-ahead matching should be performed. The searchable name-part may be determined based on a position of the selection device on the selected resource name. The searchable name-part may comprise a portion of the resource name demarcated by at least one delimiter (e.g., a period, a space, an asterisk, a hyphen, or other pre-defined symbol). For example, a position of a pointer of the selection device (e.g., a mouse pointer, a position at which the stylus touches the touch screen, etc.) may be determined. Position ranges for each of the name-parts of the selected resource name may also be determined. The position of the pointer of the selection device may be compared with the position ranges for each of the name-parts to determine the searchable name-part. The flow continues at block 210 in FIG. 3.

At block 210, it is determined whether precision type-ahead resource navigation is enabled. When precision type-ahead resource navigation is enabled, the type-ahead navigation feature can be initiated against any character of the searchable name-part. On the other hand, when precision type-ahead resource navigation is not enabled, the type-ahead navigation feature is initiated against a first character of the searchable name-part. If it is determined that precision type-ahead resource navigation is enabled, the flow continues at block 212. Otherwise, the flow continues at block 222.

At block 212, a searchable character position of the searchable name-part is identified. The searchable character position can indicate a character position within the searchable name-part against which the type-ahead navigation feature will be initiated. For example, for a searchable character of “B” within the searchable name-part “COBOL”, the searchable character position is “3”. This can indicate that type-ahead for resource navigation is initiated against the third character of the searchable name-part of each of the resource names in the resource navigation window. The searchable character position may be determined by comparing the position of the pointer of the selection device to positions or position ranges for individual characters of the searchable name-part. For the above example, it may be determined that a pixel value corresponding to the position of the pointer of the selection device is 130 and that letter B comprises pixel values 125 through 132. Thus, it may be determined that the searchable character is “B”. The flow continues at block 214.

At block 214, a visual indication of the searchable character in the searchable name-part of the selected resource name is presented. For example, the font size, color, and/or emphasis of the searchable character may be varied, the searchable character may be underlined, the searchable character position may be indicated in a pop-up window, etc. The user may have an option of verifying the searchable character position e.g., by clicking on a button to confirm selection of the searchable character position. In some implementations, the user may have an option of changing the searchable character position (e.g., by releasing the selection device and selecting another character, moving the searchable character position to the left or right using arrow keys, etc). The flow continues at block 216.

At block 216, an input character is detected. The input character may be detected in response to detecting a key stroke on a keyboard. The input character may be used to search through the searchable name-part of available resource names and identify a resource that comprises the input character at the searchable character position. Detecting the input character may initiate the type-ahead navigation feature against the searchable name-part beginning at the searchable character position of the searchable name-part. In some implementations, the user may be required to select the searchable name-part using the selection device while indicating the input character. In another implementation, after the searchable name-part and the searchable character position is determined, the user may no longer be required to select the searchable name-part. The flow continues at block 218.

At block 218, a next resource name in the resource navigation window is identified such that the searchable name-part of the next resource name comprises the input character at the searchable character position. The searchable name-part of each of the resource names in the resource navigation window may be analyzed to locate the next resource name where the character at the searchable character position equals the input character. The flow continues at block 228.

At block 228, the next resource name in the resource navigation window is selected. The flow 200 moves from blocks 218 and 226 after the next resource name is identified. In some implementations, navigation focus may be shifted from the selected resource name (selected at block 202 in FIG. 2) to the next resource name in the resource navigation window. In another implementation, the next resource name may be highlighted. The flow continues at block 230.

At block 230, it is determined whether a next input character is received. The next input character may be received as a next character is a sequence of characters typed in quick succession to refine the type-ahead matching. In some implementations, it may be determined whether a time interval between detecting the input character at block 216 or 224 (“first input character”) and the next input character is less than a pre-determined (or user-configurable) time interval. The next input character may be treated as the next character in the sequence of characters against which the type-ahead matching should be performed if the interval between detecting the first and the next input characters is less than the pre-defined time interval. Otherwise, the next input character may be treated as a new first input character for performing a new type-ahead matching against the searchable name-part. In other implementations, the input character may be treated as the next character in the sequence of characters against which the type-ahead matching should be performed irrespective of the time difference between detecting the first and the next input characters. If it is determined that the next input character is received, the flow continues at block 232. Otherwise, the flow ends.

At block 232, a resource name in the resource navigation window is identified such that the searchable name-part of the resource name comprises the first input character and the next input character as consecutive characters in the resource name. The resource name may be the resource name identified at either block 218 or 226 or may be another resource name in the resource navigation window. Referring to the example of FIG. 1, on typing “L” as the first input character while selecting a third-level name-part, navigation focus is shifted to “MASTEVE.IDE.LISTING”. If the user types “O” as the next input character, the navigation focus is shifted to “MASTEVE.IDE.LOAD” to reflect consecutive characters “LO” in the third-level name-part of the resource name. However, if the user types “I” as the next input character, the navigation focus remains on “MASTEVE.IDE.LISTING” to reflect consecutive characters “LI” in the third-level name-part of the resource name. From block 232, the flow loops back to block 228 where the identified resource name is selected and it is determined whether a next input character is received.

At block 222, a visual indication of the searchable name-part of the selected resource name is presented. As described earlier, font characteristics (e.g., color, size, emphasis, etc.) of the searchable name-part may be varied, the searchable name-part may be indicated on a display device, a numeric indication of the searchable name-part may be presented, etc. Also, the user may confirm the searchable name-part by e.g., clicking on a “confirm” button. The user may change the searchable name-part by clicking on another name-part of the resource name, selecting an alternate searchable name-part by using arrow keys, etc. From block 222, the flow continues at block 224.

At block 224, the input character is detected. As described earlier, the input character may be used to search through the searchable name-part of available resource names and identify a resource that begins with the input character. Detecting the input character may initiate the type-ahead navigation feature against the searchable name-part beginning at a first character position of the searchable name-part. The flow continues at block 226.

At block 226, a next resource name in the resource navigation window is identified such that the searchable name-part of the next resource name begins with the input character. The searchable name-part of each of the resource names in the resource navigation window may be analyzed to identify the next resource name where a first character of the searchable name-part equals the input character. The flow continues at block 228, where the next resource name in the resource navigation window is selected.

FIG. 4 is a flow diagram illustrating example operations for another embodiment of a position sensitive type-ahead navigation feature. Flow 400 begins at block 402.

At block 402, a selection of a resource name in a resource navigation window is detected. The resource name may be selected by using a mouse to point and click on the resource name. The resource name may also be selected by pressing a combination of keys on a keyboard, touching a finger or a stylus to a touch screen, speaking an audio command, etc. The flow continues at block 404.

At block 404, a numeric indication of a searchable name-part is received. The numeric indication is received in response to a user indicating a number associated with the searchable name-part. The user input is indicated by means of a dashed line between blocks 402 and 404. The user may indicate the number associated with the searchable name-part by typing the number on a keyboard, using a mouse pointer (or other suitable selection device) to indicate the number on a virtual keypad, etc. For example, to indicate type-ahead matching should be performed against a fourth name-part of the resource names, the user may input the number “4”. The flow continues at block 406.

At block 406, a visual indication of the searchable name-part is presented. As described earlier, a font size, color, emphasis, etc. of the searchable name-part may be varied, the searchable name-part may be underlined, presented on a display device, etc. The user may verify the searchable name-part by clicking on a button to confirm the searchable name-part. In some implementations, the user may have an option of changing the searchable name-part (e.g., by releasing the selection device and selecting another name-part, selecting an alternate searchable name-part by using arrow key, etc). The flow continues at block 408.

At block 408, an input character is detected. The input character may be identified in response to detecting a key stroke on a keyboard, a selection device on a virtual keyboard, a spoken character in a voice command, etc. Detecting the input character may initiate the type-ahead navigation feature against a first character of the searchable name-part. The flow continues at block 410.

At block 410, a next resource name in the resource navigation window is identified such that the searchable name-part of the next resource name begins with the input character. The searchable name-part of each resource name in the resource navigation window may be analyzed to identify the next resource name. For example if the input character is “S”, and the searchable name-part was identified as a third level name part, the third level name part of each resource in the resource navigation window may be analyzed to locate a first resource such that the third-level name part of the resource begins with the letter “S”. The flow continues at block 412.

At block 412, navigation focus is shifted to the next resource name in the resource navigation window. For example, the next resource name may be highlighted. As another example, the selected resource name (selected at block 402) may be unselected and the next resource name may be selected. From block 412, the flow ends.

It should be noted that the operations described in the flow diagrams (FIGS. 2-4) are examples meant to aid in understanding embodiments, and should not be used to limit embodiments or limit scope of the claims. Embodiments may perform additional operations, fewer operations, operations in a different order, operations in parallel, and some operations differently. For example, after the searchable name-part or the searchable character position is identified, the user may initiate a position based type-ahead navigation feature by pressing a key on a keyboard, speaking a character (e.g., for voice recognition), clicking on a character on a virtual keyboard, etc. In some implementations, the position based type-ahead navigation feature may be initiated against the searchable name-part/the searchable character position until the user disables the position based type-ahead navigation feature, or until the user identifies a new searchable name-part/a new searchable character position. The user may identify the new searchable name-part/the new searchable character position using any suitable technique described in blocks 208 or 212 of FIG. 2, or 404 of FIG. 4.

Although FIGS. 2-4 describe presenting a visual indication of the searchable name part/searchable character position of the selected resource name, in some implementations, the searchable name part/searchable character position of all the resource names in the resource navigation window may be visually indicated. For example, on determining that a third level name part if the searchable name-part, a resource navigation unit may change a font color of the third level name-part of each of the resource names presented in the resource navigation window.

Also, in some implementations, a numeric indication may be used to indicate the searchable character position. After the user specifies the numeric indication of the searchable name-part, an option for enabling precision type-ahead resource navigation may be presented. The user may enable precision type-ahead resource navigation (e.g., by pressing “Y” on the keyboard) and specify the numeric indication of the searchable character position by typing the searchable character position (e.g., typing “3” for the third character position within the searchable name-part). Subsequent characters may be used to initiate type-ahead matching against the searchable name-part beginning at the searchable character position.

Lastly, although FIG. 4 describes techniques for indicating the numeric indication of the searchable name-part, in some implementations, on systems where resource names may begin with a number (e.g., on a Windows based operating system), the position based type-ahead navigation feature via a keyboard as described with reference to FIG. 4 may be initiated in response to a user selecting a menu option or clicking on a GUI object. For example, in addition to presenting a list of resource names in the resource navigation window, an option for enabling position-based type-ahead navigation feature may also be presented. On enabling the position-based type-ahead navigation feature, the user may specify the numeric indication of the searchable name-part, and then specify one or more characters for initiating the type-ahead matching.

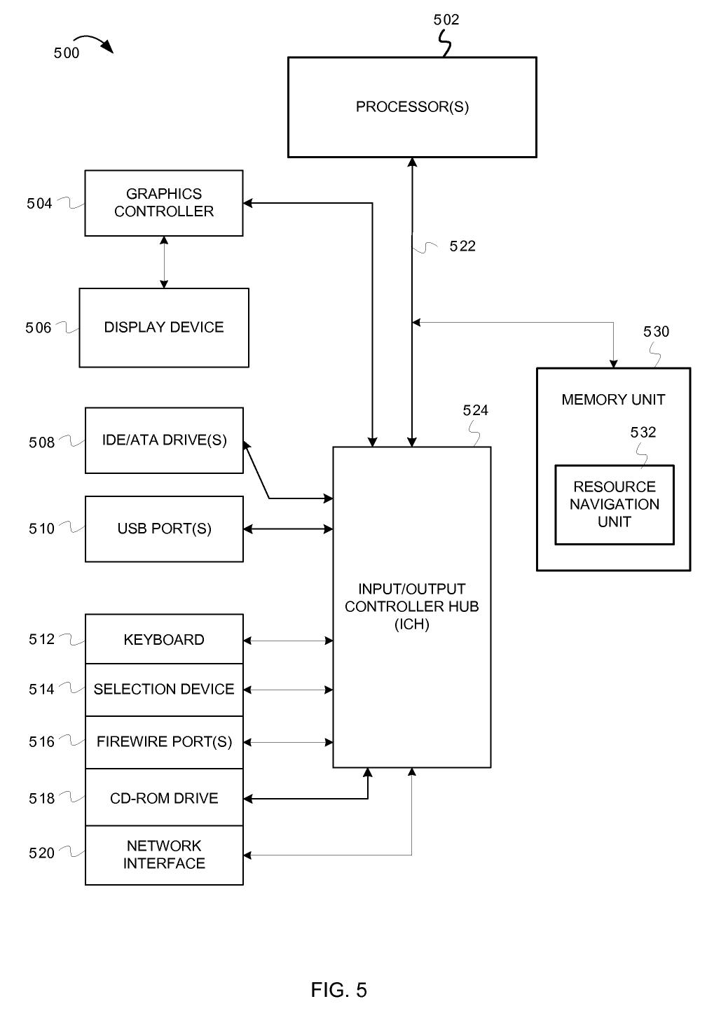

FIG. 5 is an example block diagram of a computer system 500 configured for position sensitive type-ahead matching. The computer system 500 includes a processor 502. The processor 502 is connected to an input/output controller hub 524 (ICH), also known as a south bridge, via a bus 522 (e.g., PCI, ISA, PCI-Express, HyperTransport, etc). A memory unit 530 interfaces with the processor 502 and the ICH 524. The main memory unit 530 can include any suitable random access memory (RAM), such as static RAM, dynamic RAM, synchronous dynamic RAM, extended data output RAM, etc.

The memory unit 530 comprises a resource navigation unit 532. The resource navigation unit 532 implements functionality for initiating a position sensitive type-ahead navigation feature as described with reference to FIGS. 1-4. The resource navigation unit 532 detects a selection of a resource name, determines (based on a user input) a searchable name-part and/or a searchable character position against which type-ahead matching should be initiated. The resource navigation unit 532 also searches through the searchable name-part of available resource names and identifies a first resource name such that the searchable name-part of the identified resource name comprises (beginning at the searchable character position) a character inputted by the user. The resource navigation unit 532 shifts navigation focus to the identified resource name.

The ICH 524 connects and controls peripheral devices. In FIG. 5, the ICH 524 is connected to IDE/ATA drives 508 (used to connect external storage devices) and to universal serial bus (USB) ports 510. The ICH 524 may also be connected to a keyboard 512, a selection device 514, firewire ports 516, CD-ROM drive 518, and a network interface 520. The ICH 524 can also be connected to a graphics controller 504. The graphics controller is connected to a display device 506 (e.g., monitor). In some embodiments, the computer system 500 can include additional devices and/or more than one of each component shown in FIG. 5 (e.g., video cards, audio cards, peripheral devices, etc.). For example, in some instances, the computer system 500 may include multiple processors, multiple cores, multiple external CPU's. In other instances, components may be integrated or subdivided.

Embodiments may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

While the embodiments are described with reference to various implementations and exploitations, it will be understood that these embodiments are illustrative and that the scope of the inventive subject matter is not limited to them. In general, techniques for a location sensitive type-ahead matching for resource navigation as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
identifying a searchable name-part of a first resource name presented with a resource navigation graphical user interface in response to selecting of the first resource name, wherein the searchable name-part comprises a searchable resource name portion demarcated with at least one delimiter;
in response to input of a sequence of characters, searching the searchable name-part of a plurality of resource names accessible via the resource navigation graphical user interface for the sequence of characters;
identifying a second of the plurality of resource names that has the searchable name part beginning with the sequence of characters; and
shifting focus from the first resource name to the second of the plurality of resource names in the resource navigation graphical user interface.

2. The method of claim 1, wherein said identifying the searchable name-part of the first resource name with the resource navigation graphical user interface in response to selecting of the first resource name comprises presenting a visual indication of the searchable name-part, wherein said presenting the visual indication of the searchable name-part comprises one of varying a font size of the searchable name-part of the first resource name, varying a font emphasis of the searchable name-part of the first resource name, and highlighting the searchable name-part of the first resource name.

3. The method of claim 1, wherein said identifying the searchable name-part of the first resource name presented with the resource navigation graphical user interface is in response to determining that a time interval for the selecting of the first resource name is greater than a threshold time interval.

4. The method of claim 1, further comprising:
detecting a selection of a third of the plurality of resource names in the resource navigation graphical user interface;
determining that a time interval for the selection of a third of the plurality of resource names is less than a threshold time interval; and
presenting content of a resource corresponding to the third of the plurality of resource names.

5. The method of claim 1, wherein said identifying the searchable name-part of the first resource name presented with the resource navigation graphical user interface further comprises:
determining a cursor position in the first resource name;
determining a plurality of a range of positions such that each of the plurality of the range of positions corresponds to respective ones of a plurality of name-parts that comprise the first resource name;
successively comparing the plurality of the range of positions with the cursor position to determine the range of positions within which the cursor position lies; and
identifying one of the plurality of name-parts associated with the range of positions within which the cursor position lies as the searchable name-part.

6. The method of claim 5, wherein said determining the plurality of the range of positions such that each of the plurality of the range of positions corresponds to respective ones of the plurality of name-parts that comprise the first resource name further comprises identifying at least one delimiter demarcating each of the plurality of name-parts that comprise the resource name.

7. The method of claim 6, wherein the delimiter comprises one of a period, a hyphen, an asterisk, an underscore, and a space.

8. The method of claim 1 further comprising:
identifying a second searchable name-part of a third of the plurality of resource names presented with the resource navigation graphical user interface in response to selecting of the third of the plurality of resource names and in response to receiving a numeric indication of the second searchable name-part;
presenting a visual indication of the second searchable name-part of the third of the plurality of resource names;
in response to input of a second sequence of characters, searching the second searchable name-part of the plurality of resource names accessible via the resource navigation graphical user interface for the second sequence of characters;
identifying a fourth of the plurality of resource names that has the second searchable name-part beginning with the second sequence of characters; and
shifting focus from the third of the plurality of resource names to the fourth of the plurality of resource names in the resource navigation graphical user interface.

9. A method comprising:
identifying an intermediate character position that corresponds to a character position indicated in a first resource name presented with a resource navigation graphical user interface;
in response to an input of a sequence of characters, searching from the intermediate character position of a plurality of resource names, accessible via the resource navigation graphical user interface, for the sequence of characters;
identifying a second of the plurality of resource names that comprises the sequence of characters beginning at the intermediate character position of the second of the plurality of resource names; and
shifting focus from the first resource name to the second of the plurality of resource names in the resource navigation graphical user interface.

10. The method of claim 9, further comprising:
identifying a searchable name-part of the first resource name in response to selecting of the first resource name, wherein the searchable name-part comprises a searchable resource name portion demarcated with at least one delimiter; and
determining the intermediate character position within the searchable name-part indicated in the first resource name.

11. The method of claim 10, wherein the determining the intermediate character position within the searchable name-part indicated in the first resource name is in response to one of determining a cursor position of a selection device used for the selecting of the first resource name, and determining a numeric indication of the intermediate character position.

12. A computer program product for position sensitive type-ahead matching, the computer program product comprising:
a computer usable medium having computer usable program code embodied therewith, the computer usable program code configured to:
identify a searchable name-part of a first resource name presented with a resource navigation graphical user interface in response to selecting of the first resource name, wherein the searchable name-part comprises a searchable resource name portion demarcated with at least one delimiter;
search, in response to input of a sequence of characters, the searchable name-part of a plurality of resource names accessible via the resource navigation graphical user interface for the sequence of characters;
identify a second of the plurality of resource names that has the searchable name part beginning with the sequence of characters; and
shift focus from the first resource name to the second of the plurality of resource names in the resource navigation graphical user interface.

13. The computer program product of claim 12, wherein the computer readable program code configured to identify the searchable name-part of the first resource name presented with the resource navigation graphical user interface is in response the computer readable program code determining that a time interval for the selecting of the first resource name is greater than a threshold time interval.

14. The computer program product of claim 12, wherein the computer readable program code configured to identify the searchable name-part of the first resource name presented with the resource navigation graphical user interface further comprises the computer readable program code configured to:
determine a cursor position in the first resource name;
determine a plurality of a range of positions such that each of the plurality of the range of positions corresponds to respective ones of a plurality of name-parts that comprise the first resource name;
successively compare the plurality of the range of positions with the cursor position to determine the range of positions within which the cursor position lies; and
identify one of the plurality of name-parts associated with the range of positions within which the cursor position lies as the searchable name-part.

15. The computer program product of claim 14, wherein the computer readable program code configured to determine the plurality of the range of positions such that each of the plurality of the range of positions corresponds to respective ones of the plurality of name-parts that comprise the first resource name further comprises the computer readable program code configured to identify at least one delimiter demarcating each of the plurality of name-parts that comprise the resource name, wherein the delimiter comprises one of a period, a hyphen, an asterisk, an underscore, and a space.

16. The computer program product of claim 12, wherein the computer readable program code is configured to:
identify a second searchable name-part of a third of the plurality of resource names presented with the resource navigation graphical user interface in response to selecting of the third of the plurality of resource names and in response to receiving a numeric indication of the second searchable name-part;
present a visual indication of the second searchable name-part of the third of the plurality of resource names;
search, in response to input of a second sequence of characters, the second searchable name-part of the plurality of resource names accessible via the resource navigation graphical user interface for the second sequence of characters;
identify a fourth of the plurality of resource names that has the second searchable name-part beginning with the second sequence of characters; and
shift focus from the third of the plurality of resource names to the fourth of the plurality of resource names in the resource navigation graphical user interface.

17. The computer program product of claim 12, wherein the computer readable program code is configured to:
identify an intermediate character position that corresponds to a character position indicated in a third of the plurality of resource names presented with the resource navigation graphical user interface;
search, in response to an input of a second sequence of characters, from the intermediate character position of the plurality of resource names, accessible via the resource navigation graphical user interface, for the second sequence of characters;
identify a fourth of the plurality of resource names that comprises the second sequence of characters beginning at the intermediate character position of the fourth of the plurality of resource names; and
shift focus from the third of the plurality of resource names to the fourth of the plurality of resource names in the resource navigation graphical user interface.

18. An apparatus comprising:
a processor;
a network interface coupled with the processor; and
a resource navigation unit operable to:
identify a searchable name-part of a first resource name presented with a resource navigation graphical user interface in response to selecting of the first resource name, wherein the searchable name-part comprises a searchable resource name portion demarcated with at least one delimiter;
in response to input of a sequence of characters, search the searchable name-part of a plurality of resource names accessible via the resource navigation graphical user interface for the sequence of characters;
identify a second of the plurality of resource names that has the searchable name part beginning with the sequence of characters; and
shift focus from the first resource name to the second of the plurality of resource names in the resource navigation graphical user interface.

19. The apparatus of claim 18, wherein the resource navigation unit is further operable to:
identify a second searchable name-part of a third of the plurality of resource names presented with the resource navigation graphical user interface in response to selecting of the third of the plurality of resource names and in response to receiving a numeric indication of the second searchable name-part;
present a visual indication of the second searchable name-part of the third of the plurality of resource names;
search, in response to input of a second sequence of characters, the second searchable name-part of the plurality of resource names accessible via the resource navigation graphical user interface for the second sequence of characters;
identify a fourth of the plurality of resource names that has the second searchable name-part beginning with the second sequence of characters; and
shift focus from the third of the plurality of resource names to the fourth of the plurality of resource names in the resource navigation graphical user interface.

20. The apparatus of claim 18, wherein the resource navigation unit comprises machine-readable media.
